(19) United States
(12) Patent Application Publication
(10) Pub. No.: US 2010/0034944 A1
(43) Pub. Date: Feb. 11, 2010

(54) Use of Avocado Derivatives in Flavor Applications

(76) Inventors: Martha Lubenova Beyazova, Westfield, NJ (US); Mark L. Dewis, Matawan, NJ (US); Stephen Anthony Gravina, Rutherford, NJ (US); Kenneth Kraut, Union Beach, NJ (US); Laurence Trinnaman, Montvale, NJ (US); Ying Yang, Morganville, NJ (US); Kathryn Bardsley, Staten Island, NY (US)

Correspondence Address: INTERNATIONAL FLAVORS & FRAGRANCES INC., 521 WEST 57TH ST, NEW YORK, NY, 10019, US

(21) Appl. No.: 12/186,744

(22) Filed: Aug. 6, 2008

(51) Int. Cl. A23L 1/226

(52) U.S. Cl. 426/534

(57) ABSTRACT

The invention is directed to a method for improving, enhancing or modifying the foodstuff through the addition of an effective amount of Formula I

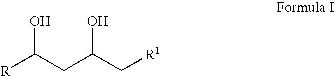

wherein R can be selected from the group consisting of —CH₂, —OH, and

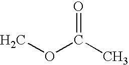

wherein R¹ can be a C₃-C₂₀ saturated or unsaturated straight chain hydrocarbon moiety.

### FIELD OF THE INVENTION

The use of avocado derivatives is disclosed as a flavor chemical suitable for incorporation in food products and related applications.

### BACKGROUND OF INVENTION

The term Umami, from the Japanese word to describe savory or meaty, is the term used to describe the unique overall fullness, savory or salivatory taste of food. Materials that exhibit this taste quality generally potentate the intensity of glutamate solutions and this is one important characteristic of umami taste. It is increasingly becoming recognized as the fifth sense of taste, the others being sour, sweet, salt and bitter. Compounds traditionally described as possessing this character are monosodium glutamate (MSG), protein hydrolysates, some L-amino acids and certain nucleotides and phosphates.

MSG is the most widely used material as a ‘taste enhancer’ where it synergizes the perception of ‘savory’ ingredients, but has also been alleged to cause allergic reaction to a proportion of the population.

Among other chemical compounds, several nucleotides have also been described to exhibit the umami effect including Adenosine 5′-(trihydrogen diphosphate), 5′-Cytidylic acid (5′-CMP), 5′-Uridylic acid (5′-UMP), 5′-Adenylic acid (5′-AMP), 5′-Guanylic acid (5′-GMP), 5′-Inosinic acid (5′-IMP) and the di-sodium salts of 5′-Guanylic acid and 5′-Inosinic acid.

Recent literature cites an extensive range of other organic compounds as taste active components of mixtures shown to give the umami taste effect. These include but are not necessarily limited to: organic acids such as succinic acid, lactic acid, saturated straight chain aliphatic acids of six, eight, fourteen, fifteen, sixteen, and seventeen carbon chain lengths, Z4,Z7, Z10,Z13,Z16,Z19-docosahexaenoic acid, Z5,Z8,Z11,Z14,Z17-eicosapentaenoic acid, Z9,Z12, Z16,Z19-octadecadienoic acid, Z9-octadecenoic acid, glutaric acid, adipic acid, suberic acid, and malonic acid. Amino acids having umami effects reported in the literature include glutamic acid, aspartic acid, threonine, alanine, valine, histidine, proline, tyrosine, cystine, methionine, pyroglutamic acid, leucine, lysine, and glycine. Dipeptides possessing umami properties include Val-Glu and Glu-Asp.

Other miscellaneous compounds having umami properties include alpha-amino adipic acid, malic acid, alpha-aminobutyric acid, alpha-aminoisobutyric acid, E2,E4-hexadienal, E2,E4-heptadienal, E2,E4-octadienal, E2,E4-decadienal, Z4-heptenal, E2,Z6-nonadienal, methional, E3,E5-octadien-2-one, 1,6-hexanediamine, tetramethylpyrazine, trimethylpyrazine, cis-6-dodecen-4-olide, glutamate glycoconjugates, fish sauce blended with anchovy paste (U.S. Patent Application 2003/0142090) and a number of naturally occurring amino-acids.

Additionally, a variety of molecules are known by those skilled in the art to provide salt enhancement, these include but are not limited to Adenosine 5′-(trihydrogen diphosphate), 5′-Cytidylic acid (5′-CMP), 5′-Uridylic acid (5′-UMP), 5′-Adenylic acid (5′-AMP), 5′-Guanylic acid (5′-GMP), 5′-Inosinic acid (5′-IMP) and the di-sodium salts of 5′-Guanylic acid and 5′-Inosinic acid, (+)-(S)-Alapyridaine (chemical name N-(1-Carboxyethyl)-6-hydroxymethyl pyridinium-3-ol), succinic acid, cetylpyridium chloride, bretylium tosylate, various polypeptides, mixtures of calcium salts of ascorbic acid, potassium chloride, calcium chloride, magnesium chloride, arginine ammonium chloride, alpha-amino acids and their corresponding hydrogen chloride, ammonium and sodium salts and a number of natural plant extracts. Uses of these materials are described in various U.S. Pat. Nos. 4,997,672; 5,288,510; 6,541,050 and U.S. Patent Application 2003/0091721.

In addition the previous cited work, our work has included the identification of new flavor materials described in U.S. Pat. No. 7,329,767 issued on Feb. 12, 2008; U.S. Pat. No. 7,098,350 issued on Aug. 26, 2006; and U.S. Publication Number 2004/0202619 filed Feb. 20, 2004.

Despite these disclosures there is an ongoing need for new flavor ingredients, particularly those that exhibit advantageous properties of enhancing or modulating flavor and more preferably lowering of MSG and/or salt levels in foodstuffs.

### SUMMARY OF THE INVENTION

One embodiment of the invention is directed to a method for improving, enhancing or modifying a foodstuff through the addition of an effective amount of Formula I

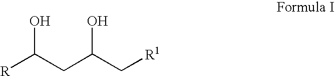

wherein R is selected from —CH₂, —OH

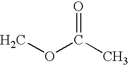

and R¹ can be a saturated or unsaturated C₃-C₂₀ straight chain hydrocarbon moiety.

In another embodiment of the invention, a compound of Structures I or Structures II is used alone or in a mixture as a flavor enhancer.

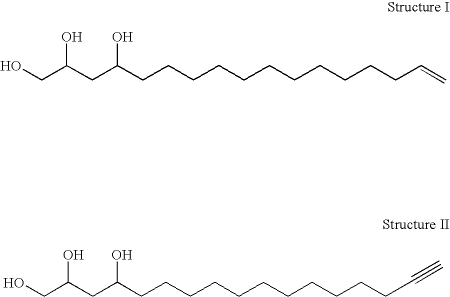

In yet another embodiment of the invention, a compound of Structures III and IV is used alone or as a mixture as a flavor enhancer,

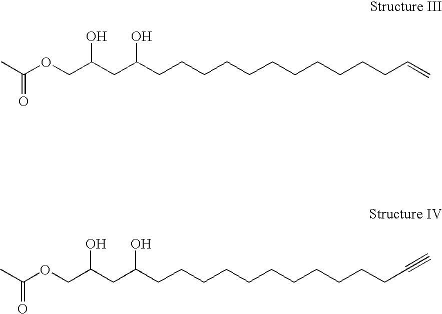

### DETAILED DESCRIPTION OF THE INVENTION

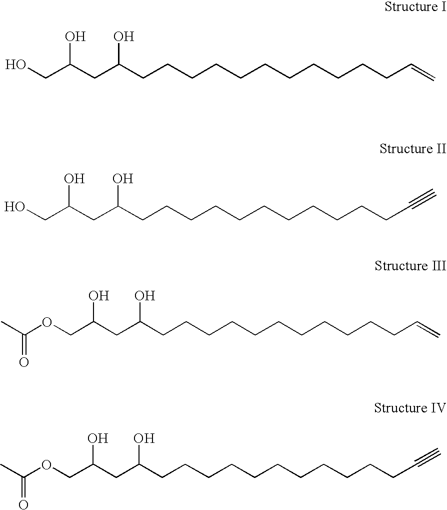

The above Structures I, II, III and IV of the invention are known by one skilled in the art as 16-heptadecene-1,2,4-triol; 16-heptadecyne-1,2,4-triol; 2,4-dihydroxy-16-heptadecen-1-yl acetate; and 2,4-dihydroxy-16-heptadecyn-1-yl acetate respectively.

In one embodiment, Structure I and Structure II can be used alone or in a mixture as a flavor enhancer.

In yet another embodiment, Structures III and IV can be used alone or in a mixture as a flavor enhancer.

It is intended herein that the compounds described herein include the isomeric mixtures of such compounds, as well as those isomers that may be separated using techniques known to those having skill in the art. Suitable techniques include chromatography such as high performance liquid chromatography, referred to as HPLC, and particularly gel chromatography and solid phase microextraction, referred to as SPME.

The term “foodstuff” as used herein includes both solid and liquid ingestible materials for man or animals, which materials usually do, but need not, have nutritional value. Thus, foodstuffs include meats, gravies, soups, convenience foods, malt, alcoholic and other beverages, soy-containing products, milk and dairy products, herbs including basil, dill weed, parsley, oregano, marjoram, sage, thyme, rosemary, mint, cilantro, tarragon, chervil, seafoods, including fish, crustaceans, mollusks and the like, candies, vegetables, cereals, soft drinks, snacks, dog and cat foods, other veterinary products and the like.

In yet another embodiment of the invention, Structures I, II, III and IV are used in savory food applications. Examples of preferred foodstuff include soups, gravies, meat dishes, snacks, marinades, and sauces.

When the compounds of this invention are used in a flavoring composition, they can be combined with conventional flavoring materials or adjuvants. Such co-ingredients or flavor adjuvants are well known in the art for such use and have been extensively described in the literature. Requirements of such adjuvant materials are that they are organoleptically compatible with the Structures I, II, III or IV and that they are ingestible acceptable and thus non-toxic or otherwise non-deleterious. Apart from these requirements, conventional materials can be used and broadly include other flavor materials, vehicles, stabilizers, thickeners, surface active agents, conditioners and flavor intensifiers.

Such conventional flavoring materials include saturated fatty acids, unsaturated fatty acids and amino acids; alcohols including primary and secondary alcohols, esters, carbonyl compounds including aldehydes and ketones; lactones; other cyclic organic materials including aryl compounds, alicyclic compounds, heterocyclics such as furans, pyridines, pyrazines and the like; sulfur-containing compounds including thiols, sulfides, disulfides and the like; proteins; lipids, carbohydrates; so-called flavor potentiators such as monosodium glutamate; magnesium glutamate, calcium glutamate, guanylates and inosinates; natural flavoring materials such as cocoa, vanilla and caramel; essential oils and extracts such as anise oil, clove oil and the like and artificial flavoring materials such as vanillin, ethyl vanillin and the like.

Specific preferred flavor adjuvants include but are not limited to the following: anise oil; ethyl2-methylbutyrate; vanillin; cis-3-heptenol; cis-3-hexenol; trans-2-heptenal; butyl valerate; 2,3-diethylpyrazine; methyl cyclopentenolone; benzaldehyde; valerian oil; 3,4-dimethoxyphenol; amyl acetate; amyl cinnamate; gamma-butyrolactone; furfural; trimethylpyrazine; phenylacetic acid; isovaleraldehyde; ethyl maltol; ethyl vanillin; ethyl valerate; ethyl butyrate; cocoa extract; coffee extract; peppermint oil; spearmint oil; clove oil; anethole; cardamom oil; wintergreen oil; cinnamic aldehyde; ethyl2-methylvalerate; gamma-hexenyl lactone; 2,4-heptadienal; methyl thiazole alcohol(4-methyl-5-.beta.-hydroxyethyl thiazole); 2-methylbutanethiol; 4-mercaptobutan-2-one; 3-mercaptopentan-2-one; 1-mercapto-2-propene; benzaldehyde; furfural; furfuryl alcohol; 2-mercaptopropionic acid; alkyl pyrazine; methylpyrazine; 2-ethyl-3-methylpyrazine; tetramethylpyrazine; polysulfides; dipropyl disulfide; benzyl methyl disulfide; alkyl thiophene; 2,3-dimethylthiophene; 5-methylfurfural; 2-acetylfuran; 2,4-decadienal; guiacol; phenylacetaldehyde; beta-decalactone; d-limonene; acetoin; amyl acetate; maltol; ethyl butyrate; levulinic acid; piperonal; ethyl acetate; octanal; valeraldehyde; hexanal; diacetyl; monosodium gulatamate; monopotassium glutamate; sulfur-containing amino acids, e.g., cysteine; hydrolyzed vegetable protein; 2-methylfuran-3-thiol; 2-methyldihydrofuran-3-thiol; 2,5-dimethylfuran-3-thiol; hydrolyzed fish protein; tetramethylpyrazine; propyl propenyl disulfide; propyl propenyl trisulfide; diallyl disulfide; diallyl trisulfide; dipropenyl disulfide; dipropenyl trisulfide; 4-methyl-2-[(methylthio)-ethyl]-1,3-dithiolane; 4,5-dimethyl-2-(methylthiomethyl)-1,3-dithiolane; and 4-methyl-2-(methylthiomethyl)-1,3-dithiolane. These and other flavor ingredients are provided in U.S. Pat. Nos. 6,110,520 and 6,333,180 hereby incorporated by reference.

Structures I, II, III or IV or compositions incorporating them, as mentioned above, can be combined with one or more vehicles or carriers for adding them to the particular product. Vehicles can be edible or otherwise suitable materials such as ethyl alcohol, propylene glycol, water and the like, as described supra. Carriers include materials such as gum arabic, carrageenan, xanthan gum, guar gum and the like.

Structures I, II, III or IV prepared according to our invention can be incorporated with the carriers by conventional means such as spray-drying, drum-drying and the like. Such carriers can also include materials for coacervating the avocado derivatives of our invention to provide encapsulated products, as set forth supra. When the carrier is an emulsion, the flavoring composition can also contain emulsifiers such as mono- and diglycerides or fatty acids and the like. With these carriers or vehicles, the desired physical form of the compositions can be prepared.

The quantity of Structures I, II, III or IV utilized should be sufficient to impart the desired flavor characteristic to the product. The quantity used will vary depending upon the ultimate foodstuff; the amount and type of flavor initially present in the foodstuff; the further processing or treatment steps to which the foodstuff will be subjected; the regional and other preference factors; the type of storage, if any, to which the product will be subjected; and the preconsumption treatment such as baking, frying and so on, given to the product by the ultimate consumer.

In general, a food composition of the invention preferably contains from about 0.00005 percent (0.5 part per million, ppm) to about 0.1 percent (1000 ppm) by weight of Structure I or II or mixtures thereof.

More preferably, food compositions may contain from about 0.0001 percent (1 ppm) to about 0.001 percent (10 ppm) by weight of Structures I or II or mixtures thereof and, even more preferably, about 0.0005 percent (5 ppm) by weight of Structures I or II or mixtures thereof.

In general, a food composition of the invention preferably contains from about 0.00005 percent (0.5 part per million, ppm) to about 0.1 percent (1000 ppm) by weight of Structures III or IV or mixtures thereof.

More preferably, food compositions may contain from about 0.0001 percent (1 ppm) to about 0.001 percent (10 ppm) by weight of Structures III or IV or mixtures thereof and, even more preferably, about 0.0005 percent (5 ppm) by weight of Structures III or IV or mixtures thereof.

Accordingly, the terminology “effective amount” and “sufficient amount” is understood in the context of the present invention to be a quantitatively adequate amount to alter the flavor of the foodstuff.

The following are provided as specific embodiments of the present invention. Other modifications of this invention will be readily apparent to those skilled in the art, without departing from the scope of this invention. As used herein, both specification and following examples all percentages are weight percent unless noted to the contrary. IFF as used in the examples is understood to mean International Flavors & Fragrances Inc.

### EXAMPLE I

### PREPARATION of STRUCTURE III 2,4-DIHYDROXY-16-HEPTADECEN-1-YL ACETATE and STRUCTURE IV 2,4-DIHYDROXY-16-HEPTADECYN-1-YL ACETATE

Dry ground avocado seeds (200 g) were extracted with ethyl acetate (400 mL) for 30 minutes at room temperature. The extract was collected by decanting from the extractor and the residual ground seeds were extracted with fresh solvent of the same composition two more times. The extracts were combined and concentrated to dryness. 120 mL of hexane was added and the reaction mixture was placed at 0° C. overnight to produce white crystals. The white crystals were separated and rinsed with cold hexane three times to obtain 100 mg of Structures III and IV with a yield of about 95% by weight. To obtain additional Structures III and IV the remaining hexane solution was placed again at 0° C. overnight to crystallize second time. The total weight of Structures III and IV compounds obtained from this work was 200 mg at a yield of about 90% by weight. In a final product, the ratio of the structure III versus structure IV is approximately 1:1 in quantity.

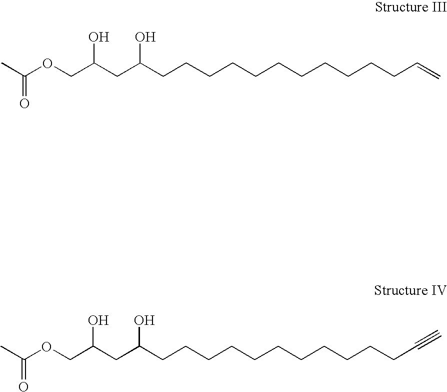

NMR spectra were recorded in CDC13 with TMS as internal standards.

The NMR spectrum of Structure III, displayed the following signals: a multiple at ca. δ 5.8 (1H), a doublet at δ 4.98 (1H), and a doublet at δ 4.75 (1H) typical of the three vinylic hydrogens of a terminal double bond CH2═CH—. Two singlets at δ 4.25 (1H) and δ 3.75 (1H) which disappeared on addition of D2O indicated the presence of two hydroxyl groups in the molecule. One acetyl group was observed at δ 2.08 (3H) and integration showed the presence of 22 methylenic hydrogens at δ 1.22. An additional signal at δ 4.13 was attributed to the presence of two hydrogens adjacent to the acetoxy group thus proving the acetylated OH to be primary. No terminal methyl group was observed.

The NMR spectrum of Structure IV, displayed the following signals: a singlet at δ 1.93 (1H) suggested the hydrogen of a terminal triple bond CH≡C—. Two singlets at δ 4.25 (1H) and δ 3.75 (1H) which disappeared on addition of D2O indicated the presence of two hydroxyl groups in the molecule. One acetyl group was observed at δ 2.08 (3H) and integration showed the presence of 22 methylenic hydrogens at δ 1.22. An additional signal at δ 4.13 was attributed to the presence of two hydrogens adjacent to the acetoxy group thus proving the acetylated OH to be primary. No terminal methyl group was observed.

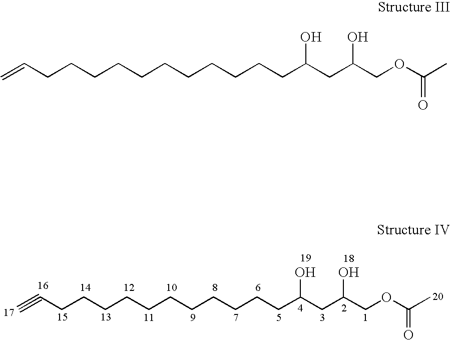

TABLE I
¹H and ¹³CNMR data for Structures (III) and (IV)

| | ¹HNMR | | ¹³CNMR |
|---|---|---|---|
| Position | Structure (IV) | Structure (III) | Structure (IV) |
| 1 | 4.14 m | 4.0 | 68.66 |
| 2 | 4.02 m | 3.69 | 72.56 |
| 3 | 1.6 | 1.55 | 39.17 |
| 4 | 3.89 m | 3.6 | 70.87 |
| 5 | 1.6 | 1.43 | 38.27 |
| 6-13 | 1.26-1.45 | 1.26-1.45 | 25.37, 28.57, |
| | | | 28.84, 29.17, 29.55, 29.62, |
| | | | 29.64, 29.66 |
| 14 | 1.5 | 1.34 | |
| 15 | 2.17 | 2.04 | 18.49 |
| 16 | | 5.8 | 68.13 |
| 17 | 1.94 | 5.0 | 84.92 |
| OH-1 | | | |
| OH-2 | 3.4 | 2.75 br | |
| OH-3 | 2.65 | | |
| CO | | | 171.31 |
| Me | 2.11 s | 2.11 | 20.96 |

¹HNMR: 500 MHz, CDCl3, TMS as internal standard;
¹³CNMR: 125.78 MHz, CDCl3, solvent at 77.1 ppm, implied multiplicities from DEPT spectrum.

TABLE II
The following table provides the flavor descriptors for the following compounds when tasted at
varying levels in a salt water solution, chicken broth solution, and IMP and MSG solution and a NaCl,
IMP and MSG solution.

| | | Chicken Broth | | |
|---|---|---|---|---|
| | | College Inn | | NaCl 0.1% |
| | | 50% reduced Na; | IMP 0.00359 g/L/ | IMP 0.00359 g/L/ |
| Concentration of | Salt Water 0.3% | Fat free | MSG 0.0508 g/L | MSG 0.0508 g/L |
| compound (ppm) | 10 ppm | 10 ppm | 20 ppm | 10 ppm |
| 2,4-Dihydroxy-16- | Fruity, bitter, | Slightly bitter, | Jalepeno pepper, | Nice umami better |
| heptadecene-1-yl-acetate | astringent, pepper | astringent | pepperoni | than 30366 |
| and 2,4-Dihydroxy-16- | skin, sausage | | | |
| heptadecyn-1-yl acetate | casing | | | |
| mixture | | | | |
| 2,4-Dihydroxy-16- | Stronger umami | lacks bitternes, nice | Nice umami | Very umami |
| heptadecene-1-yl-acetate | than 16- | umami, | | |
| | heptadecene- | waterchesnut | | |
| | 1,2,4-triol, 1- | | | |
| | acetate mixture, | | | |
| | drying and less | | | |
| | bitter, smokey | | | |
| 2,4-Dihydroxy-16- | Fuller, adds | Bitter | Very Umami | Added |
| heptadecyn-1-yl acetate | brothy character; | | Mouth-watering; | succulance/savory |
| | slightly bitter, | | potentiated overall | character; subdued |
| | serumy, soapy | | IMP/MSG impact | impact of |
| | | | | IMP/MSG/Salt |
| 16-Heptadecen-1,2,4- | Methional potato, | Metallic, off-note, | Plastic rubber note | Plastic, metallic, hay |
| triol and 16-Heptadecyn- | metallic, drying, | soybean, bloody | | note |
| 1,2,4-triol mixture | bitter, off-note, | | | |
| | plastic | | | |

TABLE III
2,4-DIHYDROXY-16-HEPTADECYNE-1-YL ACETATE and
16-HEPTADECENE-1,2,4-TRIOL, 1-ACETATE mixture (1:1)
Mixture of the Compounds dissolved in H₂O and tasted:

| | 5 ppm | 10 ppm | 20 ppm | 30 ppm | 40 ppm |
|---|---|---|---|---|---|
| Mixture alone | not noticable | not noticable | | | |
| Mixture + | not noticable | slightly increased | more mouthfeel | too high | too high |
| MSG | | savory | | | |
| Mixture + | not noticable | slightly increased savory | more | too high | too high |
| MSG; +IMP | | | mouthfeel, | | |
| | | | slight green, | | |
| | | | vegetable, | | |
| | | | celery | | |
| Mixture + | not noticable | more mouthfeel | more mouthfeel | too high | too high |
| NaCl 0.1% | | | | | |
| Mixture + | not noticable | increased Na | more mouthfeel | too high | too high |
| NaCl 0.3% | | perception; more | | | |
| | | mouthfeel | | | |

The results demonstrate that the mixture of the compound in combination with MSG, IMP, NaCl provided a desirable mouthfeel effect.

TABLE IV
2,4-DIHYDROXY-16-HEPTADECYNE-1-YL ACETATE and
16-HEPTADECENE-1,2,4-TRIOL, 1-ACETATE mixture (1:1)
Mixture of the Compounds dissolved in chicken broth and tasted in:

| | 5 ppm | 10 ppm | 20 ppm | 30 ppm | 40 ppm |
|---|---|---|---|---|---|
| Mixture | not noticeable | barely noticeable | slightly increased savory | | |
| alone | | | | | |
| +MSG | very slightly | slightly increased | slightly increased savory | | too high |
| | increased | savory | | | |
| | savory | | | | |
| +MSG; | very slightly | slightly increased | slightly increased savory | | too high |
| +IMP | increased | savory | | | |
| | savory | | | | |
| +NaCl 0.1% | slightly | enhances Na | enhances Na | enhances Na | too high |
| | enhances Na | perception | perception; | perception; enhances | |
| | perception | | enhances grease | grease notes | |
| | | | notes | | |
| +NaCl 0.3% | slightly | enhances Na | enhances Na | enhances Na | too high |
| | enhances Na | perception | perception; | perception; enhances | |
| | perception | | enhances grease | grease notes | |
| | | | notes | | |

The results demonstrate that the mixture of the compound in combination with MSG, IMP, NaCl provided a desirable enhancement of the flavor of the chicken broth.

What is claimed is:

1. A method for improving, enhancing or modifying the flavor of a foodstuff through the addition of a compound of the following formula: 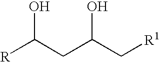
wherein R is selected from the group consisting of CH₂, —OH, and 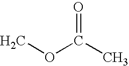
and R¹ can be a C₃-C₂₀ saturated or unsaturated straight chain hydrocarbon moiety.

2. The method of claim 1 wherein the compound is selected from the group consisting of 16-heptadecene-1,2,4-triol; 16-heptadecyne-1,2,4-triol; 2,4-dihydroxy-16-heptadecen-1-yl acetate; 2,4-dihydroxy-16-heptadecyn-1-yl acetate and mixtures thereof.

3. The method of claim 1 wherein the compound is a mixture of 16-heptadecene-1,2,4-triol and 16-heptadecyne-1,2,4-triol.

4. The method of claim 1 wherein the compound is a mixture of 2,4-dihydroxy-16-heptadecen-1-yl acetate and 2,4-dihydroxy-16-heptadecyn-1-yl acetate.

5. The method of claim 1 wherein the flavor is incorporated into a foodstuff selected from the group consisting of meats, sauces, gravies, soups, convenience foods, malt beverages, alcoholic beverages, soy-containing products, milk products, dairy products, herbs, fish, crustaceans, mollusks, candies, vegetables, cereals, soft drinks, snacks, dog food, cat foods and mixtures thereof.

6. The method of claim 5 wherein the foodstuff is a meat.

7. The method of claim 5 wherein the foodstuff is a soup.

8. The method of claim 5wherein the foodstuff is a sauce.

9. The method of claim 1 wherein the compound is at a level from about 0.5 ppm to about 1000 ppm by weight.

10. The method of claim 1 wherein the compound is at a level from about 1 ppm to about 100 ppm by weight.

11. The method of claim 1 wherein the compound is at a level from about 5 ppm to about 25 ppm by weight.

12. A combination comprising a foodstuff and a compound of the formula 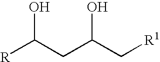
wherein R can be selected from CH₂, —OH, 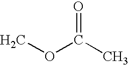
and R¹ can be a C₃-C₂₀ unsaturated or saturated straight chain hydrocarbon moiety.

13. The combination of claim 12 wherein the compound is selected from the group consisting of 16-heptadecene-1,2,4-triol; 16-heptadecyne-1,2,4-triol; 2,4-dihydroxy-16-heptadecen-1-yl acetate; 2,4-dihydroxy-16-heptadecyn-1-yl acetate and mixtures thereof.

14. The combination of claim 12 wherein the compound is a mixture of 16-heptadecene-1,2,4-triol and 16-heptadecyne-1,2,4-triol.

15. The combination of claim 12 wherein the compound is a mixture of 2,4-dihydroxy-16-heptadecen-1-yl acetate and 2,4-dihydroxy-16-heptadecyn-1-yl acetate.

16. The combination of claim 12 wherein the compound is from about 0.5 ppm to about 1000 ppm by weight in the foodstuff.

17. The combination of claim 12 wherein the compound is less from about 1 ppm to about 100 ppm by weight in the foodstuff.

18. The combination of claim 12 wherein the compound is less from about 5 ppm to about 25 ppm by weight in the foodstuff.

19. The combination of claim 12 wherein the foodstuff is selected from the group consisting of meats, sauces, gravies, soups, convenience foods, malt beverages, alcoholic beverages, soy-containing products, milk products, dairy products, herbs, fish, crustaceans, mollusks, candies, vegetables, cereals, soft drinks, snacks, dog food, cat foods and mixtures thereof.

20. The combination of claim 12 wherein the foodstuff is a meat.

21. The combination of claim 12 wherein the foodstuff is a soup.

22. The combination of claim 12 wherein the foodstuff is a sauce.
